(19) United States
(12) Patent Application Publication
(10) Pub. No.: US 2008/0095690 A1
(43) Pub. Date: Apr. 24, 2008

(54) Nano-sized needle crystal mullite film and method of making

(76) Inventor: Wei Liu, Painted Post, NY (US)

Correspondence Address: CORNING INCORPORATED, SP-TI-3-1, CORNING, NY, 14831, US

(21) Appl. No.: 11/585,477

(22) Filed: Oct. 24, 2006

(51) Int. Cl. C01B 33/26

(52) U.S. Cl. 423/327.2

(57) ABSTRACT

The present invention provides ceramic films and ceramic membranes of high stability, high permeability, and large surface area, the films and membranes comprising mullite having whisker (i.e. needle-like) crystal morphology. The invention also discloses environmentally friendly methods of producing such films and membranes. The applications include, for example, membrane ultra-filtration of gas or liquid fluids, biological assays, cell culture surfaces and catalytic coatings on automotive honeycomb substrates.

### BACKGROUND

1. Field of the Invention

The present invention relates generally to nano-sized whisker (i.e. needle-like) crystal mullite films and membranes and more particularly to an environmentally friendly method of manufacturing such mullite films and membranes.

2. Technical Background

In the field of membrane separations, thin porous materials deposited on porous supports are widely used for micro-filtration or ultra-filtration of liquid media and gas separation. The porous support functions to provide mechanical strength for the thin porous materials.

Alumina, silica, zirconia and titania are materials commonly used to make porous films and membranes. However, it is difficult to achieve both high stability and permeability using these materials. Typically, films and membranes made from the above-mentioned materials are configured in amorphous porous structures or crystal structures. There are disadvantages with amorphous or metastable porous structures in that they tend to have rapid sintering rates. For example, amorphous silica material of high surface area sinters at low temperatures, (e.g. 100° C. to 500° C.), which excludes these materials for use in high temperature filtering applications. There are also disadvantages with crystal structures. For example, the crystal structures are typically in the form of a “cube” or a “sphere”. Pore size and porosity are difficult to maintain and balance with cube or sphere-shaped crystal structures. In order to have uniform pore size distribution, cube or sphere-shaped crystal structures are preferably tightly packed. This dense packing results in low porosity and as a result, low permeability. To achieve high porosity and high permeability, the crystal structures would need to be loosely packed. Loosely packing the crystal structures would cause non-uniform pore structures and thus, reduce the strength of the resulting porous film or membrane.

Mullite (Al₂O₃—SiO₂) is one stable aluminosilicate phase in the alumina oxide (Al₂O₃) and silica oxide (SiO₂) binary system and represents an important class of ceramic oxide materials which have been used in forming porous films and membranes.

Mullite has been used to make monolithic structures such as diesel particulate filters. These monolithic structures are described in U.S. Pat. Nos. 5,198,007, 5,194,154 and 5,098,455, as well as in WO 92/11219 by Dow Chemical Company. By heating a monolith body containing Al and Si in the presence of silicon (IV) fluoride (SiF₄) gas at about 800° C. to 1500° C., the entire channel wall of the monolithic structure is converted into inter-grown needle-like mullite structures. The resulting channel is characterized as having high porosity (e.g. 50% to 70%) and high mechanical strength. The pressure drop associated with the above mentioned mullite filter is significantly lower than silicon carbide (SiC) and cordierite diesel particulate filters.

Mullite whiskers have attracted considerable interest as a composite material for enhancing the mechanical and thermal properties of metal and ceramic materials. Several methods of producing mullite crystals in whisker, fiber or rod form are known in the art. For example, S. Hashimoto and A. Yamaguchi (Journal of the European Ceramic Society 20 (2000) 397-402) disclose using a powder mixture of aluminum sulfate hydrate (Al₂(SO₄)₃), potassium sulfate (K₂SO₄) and SiO₂ for synthesis of needle-like mullite particles. Alternative methods include use of sol precursors and “high-energy” ball-milling.

Still other methods use Al or Si fluoride. U.S. Pat. Nos. 4,910,172, 4,911,902 and 4,948,766 disclose preparation of mullite whiskers with the following process:

AlF₃ and SiO₂ or AlF₃, SiO₂ and Al₂O₃ powders are formed into a green body of a desired shape and size; the green body is heated at 700° C. to 950° C. in an anhydrous SiF₄ atmosphere to form bar-like topaz crystals; and then heated in the SiF₄ atmosphere at about 1150° C. to 1700° C. to convert the bar-like topaz to needle-like single crystal mullite whiskers. The process results in a porous rigid felt structure. The individual mullite needle-like crystals made by the above mentioned method have diameters in the μm range and lengths in the tens of μm range.

However, there are disadvantages with mullite whiskers resulting from the above mentioned processes. First, the high-temperature gas-solid reaction involving SiF₄ gas is a difficult process to commercially implement due to the toxicity and corrosivity of fluoride. Second, the crystal size of the mullite whiskers prepared by the above mentioned methods is fairly large, with individual mullite needle diameters in the μm range. Crystal mullite whiskers in the μm range are useful for example, in diesel filter applications, but often these whiskers are too large for many other uses; for example, gas phase or liquid phase nano-filtration.

It would be advantageous to provide a method of manufacturing films and membranes comprising mullite whiskers where toxic and corrosive fluoride gas is not utilized; where a high temperature gas-solid reaction step is not needed to produce the films; and where membranes comprising mullite whiskers have the small diameters, high surface area, high permeability and high stability that is needed in nano-filtration applications.

### SUMMARY OF THE INVENTION

The present invention provides a method of synthesizing mullite whiskers which does not require the use of a fluorine precursor for the production of the mullite whiskers. The method comprises three major steps:
(i) preparation of sol solution with the precursor material at temperatures below 100° C.;
(ii) drying of the sol to remove volatile solvent and other chemicals; and
(iii) calcination and crystal growth at temperatures above 900° C.

In one embodiment, the above mentioned process can be used to produce mullite whiskers in a bulk powder form according to one embodiment of the present invention.

In another embodiment, the present invention provides a method of producing mullite membranes and mullite films comprising the mullite whiskers attached to a support structure.

In a further embodiment, the present invention provides a composition of mullite comprising oxides of Al, Si and W, where in the composition the atomic ratio of Al:Si:W are: Al in the range of 1.5-5, Si in the range of 0.75-1.5 and W in the range of 0.01-0.5.

### BRIEF DESCRIPTION OF THE DRAWINGS

The invention is best understood from the following detailed description when read with the accompanying drawing figures.

FIG. 1 is a schematic view of mullite whiskers attached to a support structure to form a porous film or a porous membrane according to one embodiment of the present invention.

FIG. 2A and FIG. 2B are scanning electron microscope (SEM) micrographs of mullite whiskers attached to a porous mullite support structure produced by a method utilizing tungsten (W) according to another embodiment of the present invention.

FIG. 2A is a top view of the mullite whisker texture.

FIG. 2B is a cross-sectional view of the mullite whisker layer attached to the mullite support structure.

FIG. 2C is an elemental analysis by X-ray probe of the mullite whiskers.

FIG. 3A and FIG. 3B are SEM micrographs of mullite whiskers produced by a method utilizing W attached to a porous cordierite support to form a porous membrane according to another embodiment of the present invention.

FIG. 3A is a low magnification SEM micrograph.

FIG. 3B is a high magnification SEM micrograph.

FIG. 4 is a SEM micrograph at higher magnification of mullite whiskers produced by a method utilizing W attached to a porous alpha-alumina support to form a membrane according to another embodiment of the present invention.

FIG. 5A, FIG. 5C and FIG. 5E are SEM micrographs of coating layers on the porous mullite support structure after calcined at 900° C.

FIG. 5B, FIG. 5D and FIG. 5F are SEM micrographs of coating layers on the porous mullite support structure after further grown at 1200° C.

FIG. 6A, FIG. 6C and FIG. 6E are SEM micrographs of mullite powder after calcined at 900° C.

FIG. 6B, FIG. 6D and FIG. 6F are SEM micrographs of mullite powder after further grown ay 1200° C.

### DETAILED DESCRIPTION

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

Reference will now be made in detail to the present embodiments of the invention, examples of which are illustrated in the accompanying drawings. Wherever possible, the same reference numbers will be used throughout the drawings to refer to the same or like parts.

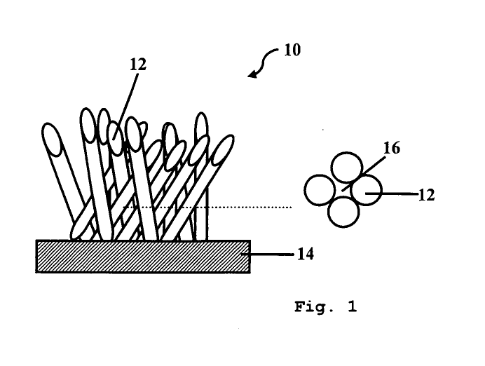

In the embodiment illustrated in FIG. 1, individual distinct mullite whiskers 12 are shown attached to a support structure 14. Several considerations are important in selecting the appropriate material for the support structure. For mullite membrane applications, the porous support structure is preferred to be of high porosity and large pore sizes (e.g. 1 μm to 30 μm), since fluid (gaseous or liquidous) needs to pass through both the mullite whisker layer and the porous support structure. Pore sizes of the present invention are preferably in the range of 3 nanometers to 200 nanometers and more preferably, less than 50 nanometers. The mullite whiskers 12 are attached to the support structure 14 to form the porous membrane or film 10 through which gaseous or liquidous material can pass and by which particulate can be filtered. The pressure drop associated with the fluid passage is preferably minimized.

The porous support structure 14 should preferably exhibit the following characteristics for membrane applications:
(i) a total porosity, as measured by Hg intrusion of greater than 30%;
(ii) a high permeability; and pores exhibiting good connectivity, a greater than sub-micron average pore size; and
(iii) a narrow size distribution.

### The combined effect of these properties is that the porous support will exhibit both a good filtration efficiency and permeability such that the porous support will be suitable for most micro-filtration and ultra-filtration applications.

For mullite film applications the support structure can vary in porosity and in pore size, because in those applications utilizing mullite films little or no fluid passes through the support structure/substrate. However, the support structure preferably has adequate thermal and hydrothermal stability so that it does not collapse during the calcination process. For most applications the support structure should exhibit a sufficiently high mechanical strength and reasonably high resistance to chemical attack, similar to quartz material.

Alumina, mullite, SiC and cordierite are all adequate support structure materials either in a form of porous structures for filtration applications utilizing membranes or in a form of dense structures for film applications.

The method of making the mullite whiskers of the present invention comprises:
(1) Preparing a sol comprising Al, Si and catalyst.
(2) Applying the homogenous sol solution and drying.
(3) Calcining and growing the mullite whiskers on the coated support structure from the dried sample.

Regarding Step (1), in order to prepare the sol, precursor salts such as Al chloride, tetraethoxysilane (TEOS) and a tungstate compound are mixed with de-ionized water and allowed to react with each other at temperatures of about 20° C. to about 100° C. from a few hours to about a day to form a homogeneous sol solution of desired particle size and viscosity. The amount of catalyst such as W in at % should be substantially less than the amount of Al and Si, preferably less than about 20 at % of Al and Si combined. The atomic ratio of Al:Si is preferred to be greater than 1 in order to form a pure mullite crystal phase.

Regarding Step (2), at this point, either a bulk mullite powder or a mullite film or a mullite membrane can be formed. There are several ways to produce the bulk mullite powder form from the sol solution. One example is to let the solvent gradually vaporized so that the sol is gelled. Another example is to disperse the above sol solution into small particles (less than about 100 μm) by an atomizing or a spray drying technique. The small particles are then dried to remove the excessive amount of water and other volatile components to form a mullite whisker precursor powder. The drying can be done by raising temperature or reducing partial pressure of the solvent or combination of both.

Further regarding Step 2, in order to produce the mullite films or the mullite membranes, the above sol solution is applied onto a support structure to form a coating layer less than about 100 μm in thickness. Many techniques can be used to deposit the coating layer onto the support structure, such as dip-coating, slip-coating, spin-coating, aerosol deposition. The coated support structure is then dried by raising temperature or reducing partial pressure of the solvent or combination of both. The drying temperature is preferably from 20° C. to 400° C. The drying time can be from a few hours to a few days.

Regarding Step (3) the calcination process is used to burn out any residual organic materials in the sample. The growing process is used to allow the Al, Si, and W atoms nuclear and grow into the needle-like crystals/whiskers. One attribute of the present invention is that the needle-like crystal growth can be conducted in an O₂ and/or N₂ containing environment. This attribute allows the calcination process and the growth process to occur simultaneously in one process. In the growth and calcination process, the dried sample (i.e. the mullite whisker precursor powder or the coated support) derived from the above sol is heated from a few hours to a few days at temperatures above 400° C. In order to promote the growth of the Al and Si precursors into mullite whiskers (needle-like crystals) in the presence of the catalyst promoter, the growth temperature is preferably in the range of 900° C. to 1500° C.

The mullite whisker membranes are useful for ultra-filtration of liquid or gas fluids, or as pre-coating layer applied to a porous support structure. For these applications, the opening size of the mullite whisker membrane preferably is in the range of about 5 nm to about 200 nm. The mullite whisker membrane of high surface area can be used for catalyst supports, for cell growth, for protein or DNA assay and the like. The needle-like structure may enable better anchoring of cells on the support and better retention of protein or DNA particles. Since the mullite whiskers are pure inorganic crystal structures calcined at high temperature (900° C. to 1500° C.), there will not be a risk of introducing contaminants in biological applications.

One advantage of the mullite whisker needle-like crystal structure of the present invention is that the surface area is determined by the diameter and length of the individual whisker. Consequently, since the length of the individual whisker can be fairly long (up to tens of μm) and the diameter can be small (˜10 nm), the whisker can thus maintain a large surface area. Similarly, as shown in FIG. 1, the pore opening 16 of the mullite membranes and the mullite films can be controlled by the whisker diameter 12. The pore opening coupled with the high aspect ratio of whisker length to diameter enables high permeability and strength.

The ratio of external surface area of a single mullite whisker needle-like crystal structure to its volume can be determined using the following formula:

$${SV}_{V} = \frac{π {d}_{c} l}{\frac{π {d}_{c}^{2} l}{4}} = \frac{4}{{d}_{c}}$$

wherein d_{c}=diameter of the whisker; and

l=length of the whisker.

For example, a single mullite whisker having a diameter of 10 nm, the specific surface area, that is, surface area per unit volume (SVv)=4×10⁸ m²/m³ or 400 m²/cc. Clearly, a small whisker diameter is preferred in order to obtain a large specific surface area. The whisker diameter of present invention is preferred to be from about 10 nm to about 200 nm, while the aspect ratio (ratio of length to diameter) is >1 or >5. The diameter and the length of a single mullite whisker can be affected by the precursor composition (Al, Si, catalyst and water content), the sol properties such as colloidal particle size and calcination and growth process. Generally, longer times and/or higher temperatures favor the formation of long needle-like crystals.

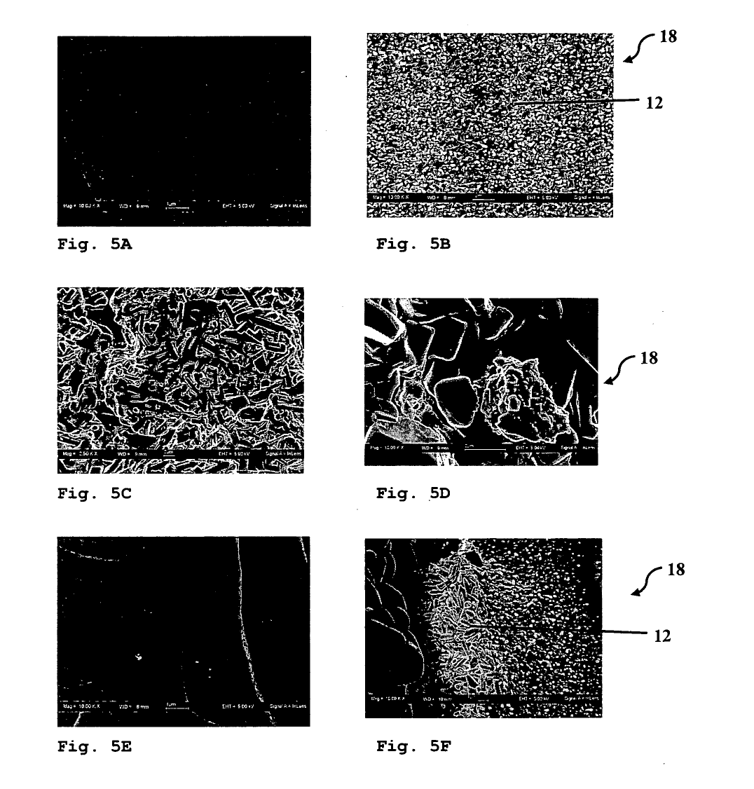

The mullite shown in FIG. 5C and FIG. 5D were prepared by using a conventional sol-gel process; that is, an Al/Si sol without the W catalyst. The mullite shown in FIG. 5D lacks the desired needle-like crystal morphology as discussed above.

The conventional methods previously mentioned herein teach the preparation of bulk mullite whiskers using a source of fluorine. Three problems are associated with this prior approach. First, these methods involve high-temperature gas/solid reactions. Second, the high-temperature reactions are performed in an atmosphere of SiF₄ and/or HF. Third, the resulting whiskers have large diameters, in the micron range. For comparison purpose, conventional methods as described in (U.S. Pat. Nos. 4,910,172, 4,911,902 and 4,948,766) are summarized as the follows:
(1) AlF₃ and SiO₂ or AlF₃, SiO₂, and Al₂O₃ powders are formed into a green body of a desired shape and size;
(2) the green body is heated at 700° C. to 950° C. in an anhydrous SiF₄ atmosphere to form bar-like topaz crystals; and
(3) heated in the SiF₄ atmosphere at about 1150° C. to 1700° C. to convert the bar-like topaz to needle-like single crystal mullite whiskers.

In contrast to the methods described in the foregoing patents, an advantage of the present invention is that the mullite whiskers can be grown without the need of a source of fluorine (e.g. SiF₄ or HF gas atmosphere) during the growth process. The method of making mullite whiskers of the present invention provides a safe and environmentally friendly process without the associated health and safety issues created with methods using a source of fluorine. In addition, the method of the present invention also has the advantage of lower manufacturing costs.

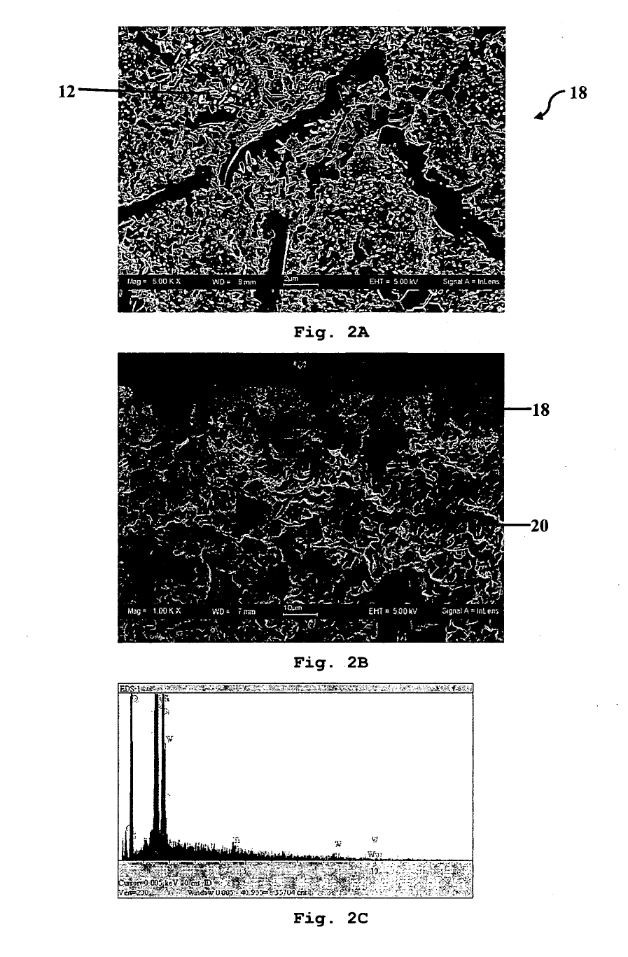

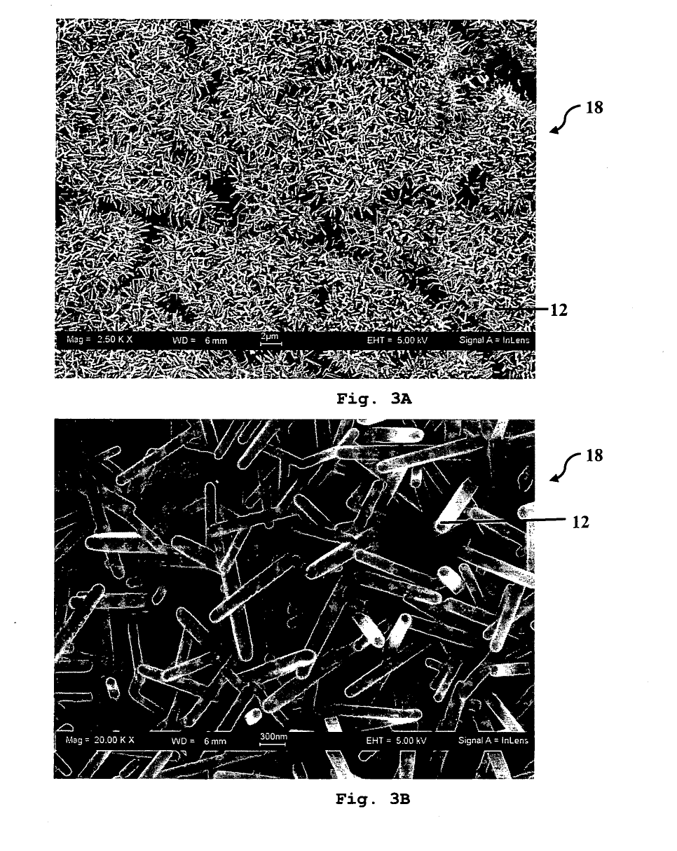

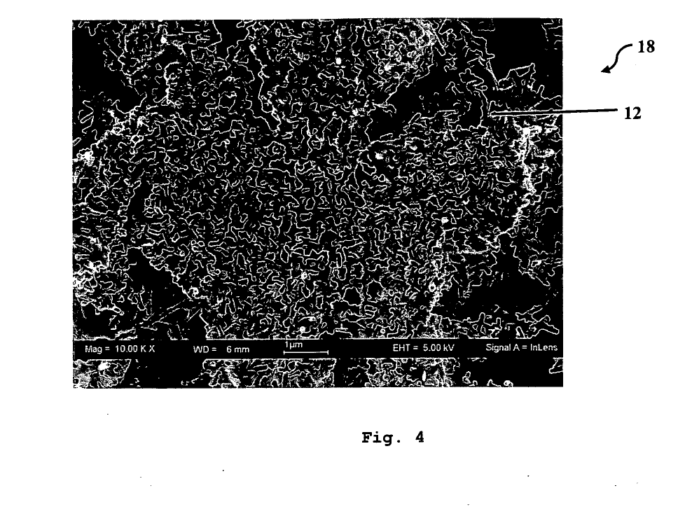

Mullite whiskers produced using the methods described by the present invention are found to be more uniform with respect to shape and size. It is surprisingly found that addition of a catalyst promoter, such as W, enables the formation of the mullite needle-like crystals having a very distinct and distinguishable whisker or rod-shaped form as shown in FIG. 2A, FIG. 2B, FIG. 3 and FIG. 4. The resulting mullite films and membranes comprising these mullite whiskers are also more uniform with respect to shape and size as compared to conventional films and membranes.

Mullite whisker synthesis according to the present invention is demonstrated by the following examples.

### EXAMPLE 1

A sol was made with anhydrous AlCl₃, tetraethoxysilane (TEOS), ammonium tungstate and de-ionized water, in a molar ratio of 16:4:1:55, respectively. AlCl₃ is the precursor for Al. Although AlCl₃ was used in this preparation, aluminum alkoxide having the formula Al(OR)₃, wherein R is a carbon chain of 1 to 8 carbon atoms can also be used. R may be either straight or branched. Examples of such alkoxides are methoxide, ethoxide, isopropoxide, propoxide, butoxide, isobutoxide, amyloxide, hexoxide, octoxide, 2-ethyl-butoxide, 2-ethyl-hexoxide and the like. The preferred alkoxide is aluminum isopropoxide.

TEOS is the precursor for Si. Although TEOS was used in this preparation, silicon (Si) precursors which are organic silicon compounds which can be hydrolyzed in the solution, for example compounds comprising silane may also be used.

Ammonium tungstate is an additive (catalyst) to facilitate the formation of needle-like crystals. Although ammonium tungstate was used in this preparation, tungstic acid or tungstic salts or a combination thereof may be used.

The mixture was heated for a time in the range of 3 to 6 hours under stirring at 60° C. to 70° C. The resulting sol was used to coat channel walls of a cordierite monolith of channel size about 1.2 mm, a mullite monolith of channel size about 1 mm and a α-alumina monolith of channel size 1 mm. The coated monoliths were dried under ambient room conditions for 16 hours, placed inside an oven to dry for another 7 hours at 100° C. and further dried in the oven at 250° C. for 16 hours. The mullite whisker growth was conducted in a muffle furnace in static air by raising temperature from room temperature to at 1180° C. at 10° C./min, holding for 6 hours at 1180° C., and cooling down to 20° C. at 10° C./min. The coating layer increased weight from about 2 weight % to about 5 weight %.

FIG. 2A and FIG. 2B show the micro-structure of the mullite whisker coating layer 18 after growth at 1180° C. on the mullite support structure 20.

FIG. 3A and FIG. 3B show the micro-structure of the mullite whisker coating 18 layer after growth at 1180° C. on the cordierite support structure.

FIG. 4 shows the micro-structure of the mullite whisker coating layer 18 after growth at 1180° C. on the alpha-alumina support structure.

Using the method of the present invention, mullite whiskers 12 were obtained on three different support structure materials: mullite, α-alumina and cordierite. On the mullite and cordierite support structures, the mullite whiskers were 10 to 100 nanometers in diameter and 1˜3 μm in length. Elemental analysis by X-Ray of the mullite whisker coating layer is also shown in FIG. 2C. The elemental analysis confirms that the major components in the mullite coating layer are O, Al, Si, and W. Monolith support structures can be produced by processes well known in the art, for example by extrusion through a twin screw process or ram process.

The cracks apparent in the coating layer shown in FIG. 2A, FIG. 2B, FIG. 3A and FIG. 4 may be due to uncontrolled drying conditions used in the preparation of the sample. These cracks can be minimized by carefully controlling the drying and the calcination processes and/or also be filled by multiple coatings. Some anti-cracking organic additives known in the thin film or membrane coating art, such as polyethylene glycol, may be added into the sol solution to mitigate the cracking issues.

### EXAMPLE 2

Three sols of different Al/Si/W ratios were made with the AlCl₃, tetraethoxysilane (TEOS), ammonium tungstate and de-ionized water. Sol#1, sol#2 and sol#3 were prepared in which the molar ratios of Al/Si/W were 4/1/0.25, 4/1/0, and 3/2/0.25, respectively. The sols were prepared using the same procedure and conditions as used in Example 1. The resulting sols were used to coat channel walls of a mullite monolith support structure with a channel diameter of 1.8 mm by a dip coating technique. The coated support structures were dried and calcined in the same tubular furnace in 100 standard cubic centimeters (sccm) of air flow with the following temperature profile: raise the temperature from room temperature to 60° C. at 2° C./minute, hold for 5 hours at 60° C., ramp to 120° C. at 2° C./minute, hold for 10 hours at 120° C., ramp to 900° C. at 2° C./minute, hold for 6 hours at 900° C., cool down at 2° C./min to 20° C. SEM analysis of the sol#1 calcined at 900° C. is shown in FIG. 5A. The sample of the sol#1 calcined at 900° C. was further heated in a muffle furnace in static air by raising temperature from room temperature to at 1200° C. at 1° C./min, holding for 6 h at 1200° C., and cooling down to 20° C. at 1° C./min. The microstructure of the sol#1 after further heating at 1200° C. is shown in FIG. 5B. FIG. 5B shows that the presence of W in the sol#1 solution creates unique textures compared to the sol#2 which was prepared without any W additive as shown in FIG. 5D. After 900° C.-calcination, the texture of the coating material from the sol#1 and the sol#3, shown in FIG. 5F is much denser than that of the coated material from the sol#2, shown in FIG. 5D. After further heating at 1200° C., the coating material from the sol#1 and sol#3 evolves into needle-like crystal structures shown in FIG. 5B and FIG. 5F respectively, while the coating material from the sol#2 forms large agglomerates without any needle-like or whisker-like crystal features. The different crystal shapes derived from the sol#1 and the sol#3 suggest that the needle structure is also affected by Al/Si ratio.

### EXAMPLE 3

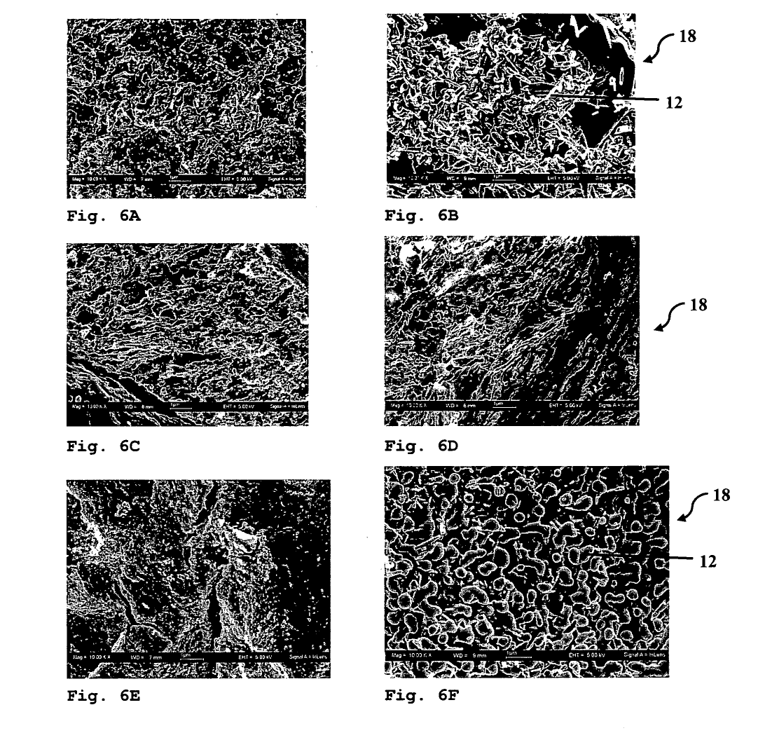

The three sols, sol#1, sol#2 and sol#3, having the same Al/Si/W ratios, respectively, as those in Example 2 were prepared and left under ambient conditions for approximately one week to form a gel. The resulting gels were dried, calcined and heated in the same manner as Example 2 to form a bulk material. FIG. 6A, FIG. 6C and FIG. 6E show the texture of the calcined and heated powder. It is difficult to assess differences in the microstructure among the three samples after calcination at 900° C. However, distinctive features are apparent after the calcined sample was further heated at approximately 1200° C. Needle or whisker-like crystals start emerging in the powder material derived from the sol#1 shown in FIG. 6B and the sol#3 shown in FIG. 6F. By contrast, the bulk powder material shown in FIG. 6D derived from the sol#2 does not show the same needle-like crystals even after further heated at approximately 1200° C. This example shows that the presence of the W catalyst in the original sol solution is critical in obtaining the mullite needle or whisker-like crystal structure in the powder form. The mullite needle-like crystal structure may also be affected by the Al/Si ratio. The example also suggests that higher heating temperatures are needed to grow the needle-like crystals, preferably above 900° C.

It will be apparent to those skilled in the art that various modifications and variations can be made to the present invention without departing from the spirit or scope of the invention. Thus, it is intended that the present invention cover the modifications and variations of this invention provided they come within the scope of the appended claims and their equivalents.

What is claimed is:

1. A method of synthesizing a mullite whisker powder comprising:
forming a mixture comprising an aluminum (Al) precursor, a silicon (Si) precursor and a catalyst;
heating the mixture at a temperature of 20° C. to 100° C. to form a homogeneous solution;
drying the homogeneous solution to remove volatile components to form a precursor powder; and
heating the precursor powder at a temperature above 900° C. to form a mullite whisker powder.

2. The method of claim 1, wherein the catalyst comprises tungsten (W).

3. The method of claim 1, wherein the catalyst is selected from the group consisting of ammonium tungstate, tungstic acid and tungstic salts.

4. The method of claim 1, wherein the aluminum precursor is selected from the group consisting of aluminum chloride and aluminum alkoxide.

5. The method of claim 1, wherein the silicon precursor comprises an organic silicon compound that can be hydrolyzed in the solution.

6. The method of claim 5, wherein the organic silicon compound is tetraethoxysilane.

7. A method of synthesizing mullite whiskers coated on a support, said method comprising:
forming a mixture comprising an aluminum (Al) precursor, a silicon (Si) precursor and a catalyst;
heating the mixture at a temperature of 20° C. to 100° C. to form a homogeneous solution;
applying the homogenous solution onto a support structure to form a coated support structure;
drying the coated support structure; and
heating the coated support structure at a temperature of 900° C. to 1500° C. to form mullite whiskers on said support structure.

8. The method of claim 7 wherein the catalyst comprises tungsten (W).

9. The method of claim 7, wherein the catalyst is selected from the group consisting of ammonium tungstate, tungstic acid and tungstic salts.

10. The method of claim 7, wherein the aluminum precursor is selected from the group consisting of aluminum chloride and aluminum alkoxide.

11. The method of claim 7, wherein the silicon precursor comprises an organic silicon compound that can be hydrolyzed in the solution.

12. The method of claim 7, wherein the organic silicon compound is tetraethoxysilane.

13. The method of claim 7, wherein the support structure is selected from the group consisting of mullite, cordierite, alumina, silicone carbide and quartz.

14. The method of claim 7, wherein the support structure is a particulate filter.

15. The method of claim 7, wherein the support structure is an extruded particulate filter.

16. A mullite composition comprising oxides of aluminum (Al), silicon (Si) and tungsten (W).

17. The mullite composition of claim 16, wherein atomic ratios of Al:Si:W comprise Al in the range of 1.5-5:Si in the range of 0.75-1.5:W in the range of 0.01-0.5.

18. The mullite composition of claim 16, wherein the atomic ratios of Al:Si:W comprise Al in the range of 2-4:Si approximately 1:W in the range of 0.1-0.25.

19. The mullite composition of claim 16, wherein said composition is in the form of mullite whiskers.

20. The mullite composition of claim 19, wherein the mullite whiskers comprise diameters of individual mullite whiskers in the range of 10 to 100 nanometers.

21. The mullite composition of claim 19, wherein the mullite whiskers comprise an aspect ratio of individual whiskers of greater than 1.

22. The mullite composition of claim 19, wherein the mullite whiskers are in the form of a membrane or a film.

23. The mullite composition of claim 22, wherein the membrane or the film has a pore size of in the range of 3 to 200 nanometers.

24. The mullite composition of claim 22, wherein the membrane or the film further comprises a support structure to which the mullite whiskers are attached.

25. The mullite composition of claim 24, wherein the support structure is selected from the group consisting of cordierite, mullite, silicon carbide, alumina, glass and quartz.

26. The mullite composition of claim 25, wherein the support structure is a particulate filter.

27. The mullite composition of claim 26, wherein the support structure is an extruded particulate filter.
